(19) United States
(12) Patent Application Publication
(10) Pub. No.: US 2013/0262281 A1
(43) Pub. Date: Oct. 3, 2013

(54) FACILITATED DISPUTE PROCESSING BY UTILIZING AN E-RECEIPT

(71) Applicants: Alexis Puchek, Austin, TX (US); Russell Bauder, San Jose, CA (US)

(72) Inventors: Alexis Puchek, Austin, TX (US); Russell Bauder, San Jose, CA (US)

(21) Appl. No.: 13/853,891

(22) Filed: Mar. 29, 2013

Related U.S. Application Data
(60) Provisional application No. 61/619,310, filed on Apr. 2, 2012.

(51) Int. Cl. G06Q 50/18; G06Q 30/00

(52) U.S. Cl. CPC G06Q 50/182; G06Q 30/016
USPC 705/35; 705/309

(57) ABSTRACT

A payment provider receives, from a user device, a request to process a dispute with a merchant for a purchase transaction, selection of an e-receipt for the disputed transaction, selections of items on the e-receipt to be disputed, and a dispute reason for each disputed item. The e-receipt may be provided either by the payment provider for the user's selection or by the user. The payment provider determines, from the e-receipt selected, information on the merchant, a description and an amount of purchase for each disputed item, and prepopulates the description and amount of purchase for each disputed item when the user requests the dispute processing. Utilizing the merchant information, and the description, the amount of purchase and the dispute reason for each disputed item, the payment provider processes the dispute with the merchant. The payment provider may inform the user of the status of the dispute processing.

### REFERENCE TO RELATED APPLICATIONS

This application claims the benefit of U.S. Provisional Application No. 61/619310, filed on Apr. 2, 2012.

### BACKGROUND

1. Field of the Invention

The present invention generally relates to a field of processing disputes from a commercial transaction.

2. Related Art

Handling a dispute arising from a commercial purchase is an experience that every consumer wishes to avoid. Being dissatisfied or finding problems with a purchased item(s) for various reasons is almost an everyday experience to most consumers. If the consumer is fortunate, the trouble can be resolved quickly without rising up to a dispute with the merchant if the dissatisfied customer is allowed to return the item at issue to the merchant via a customer service department and receive a full or satisfactory refund for the purchase price. But not all consumers may be as fortunate. In many cases, the merchant may refuse to accept the item at issue or make a refund to the consumer's satisfaction. In which case, the consumer is forced to resort to the unpleasant route of a dispute proceeding, or a proceeding for a claim, which is usually a procedure that is time-consuming and inconvenient.

In a typical dispute processing, the consumer has to file a dispute form, such as a physical form or an electronic form, with either a relevant section or department of the merchant or a third party dispute resolution service if the consumer's previous efforts to resolve the dispute with the merchant were not satisfactory. Typically, the dispute form has, sometimes, tens of pages asking the consumer to enter all kinds of information thereon including some irrelevant to the dispute or unavailable. Among the numerous sections on the form, consumers may not be able to discern, or it will take a long time to figure out, which sections of the dispute form need to be filled as essential or what kind of appropriate language to include. Many times, the information required on the dispute form can be found only from a purchase receipt. Copying all the information from the receipt into the appropriate fields on the dispute form is, in itself, a very stressful task taking much time and attention, but another problem is, in many times, the consumer is unable to locate the receipt because it has been lost or misplaced.

Recently, a number of payment providers or service providers, such as PayPal, Inc. of San Jose, Calf., that make everyday commercial transactions easier and more convenient have emerged and been growing up rapidly. Various business schemes have been developed by such payment providers to facilitate transactions between merchants and consumers, particularly payment transactions with the use of users' mobile phones or other similar portable devices equipped with suitable applications and a breadth of functionality commensurate with almost an old days' mini-computer capability.

In light of the hassles and pains involved with a consumer's processing a dispute with a merchant on her or his own, especially the trouble of manually entering all the information required to enter a typically lengthy dispute form, it would be desirable if a business scheme can be provided, with an aid of a service or payment provider and/or a mobile phone or similar devices, that facilitates a dispute or a claim processing between a consumer and a vendor/merchant regarding a purchase transaction, sometimes after an unsuccessful self-effort of the consumer to resolve the dispute, by lessening the trouble and hassle the consumer has to take in preparing and filing a dispute form and processing the dispute on her or his own.

### BRIEF DESCRIPTION OF THE FIGURES

FIG. 1 is a flowchart showing a process a payment provider performs in processing a dispute on behalf of the user who has an account with the payment provider for a purchase transaction the user has made with a merchant, according to one embodiment of the present disclosure;

FIG. 2 is block diagram of a networked system suitable for implementing the process described herein according to an embodiment of the present disclosure; and

FIG. 3 is a block diagram of a computer system suitable for implementing one or more components in FIG. 2 according to one embodiment of the present disclosure.

### DETAILED DESCRIPTION

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

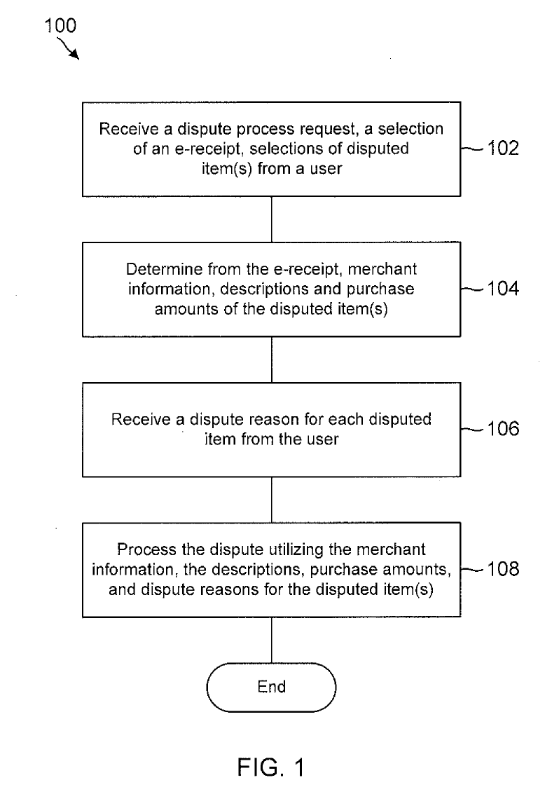

FIG. 1 is a flowchart showing a process 100 a service or payment provider performs in processing a dispute, or a claim, on behalf of the user who has an account with the payment provider for a purchase transaction the user has made with a merchant. The payment provider is any payment provider such as PayPal, Inc. of San Jose, Calif., or financial institution, which may provide, by the requests of its users, the service of making payments to some entities, such as merchants, or the service of conducting a dispute process on behalf the users. The user may be a consumer/customer, and in the process 100, disputes a particular online or in-store purchase transaction for which the payment has been already made, either in its entirety as being an invalid or unauthorized transaction, or in some particular item(s) purchased in the transaction. The payment for the disputed purchase transaction has been made to a payment recipient, such as a merchant, either through the payment provider, through a third party, or directly by the user. The merchant could be a manufacturer, distributor, retailer, or service provider.

Now referring to FIG. 1, at step 102, the payment provider receives, from the user via a user device, a user identifier, a request to process a dispute for a purchase transaction, selection of an electronic receipt (e-receipt) for the disputed purchase transaction, and one or more selections of items on the e-receipt to be disputed. Note that this information need not be received at the same time from the user device and certain information may be automatically received by the payment provider from the user device, such as the user identifier. For the process 100, the user first accesses an account the user previously has set up with the payment provider via the user device and a user application installed therein. The user device may be a server, PC, tablet, iPad™, mobile phone or any other suitable device that has a capability of wireless communication with the payment provider. The user application installed in the user device enables the user to set up an account, access the account, and make a request to the payment provider to process a dispute, on the user's behalf, with a merchant from whom the user made a purchase according to the process 100. The user application may be developed and provided either by the payment provider or a third party, which may be downloaded and installed on the user device, typically, free of charge. Accessing the account may include entering any requested user identifier, that is, identification and/or authentication information, such as a user name, email address, phone number, password, PIN, pass code, etc., into a field provided on the screen of the user device via a device keyboard or keypad, or speaking the identifier into a device microphone. Once the user has been authenticated, the user may be directed to a home screen on the user's account.

A request to the payment provider to process a dispute with a merchant or vendor for a purchase transaction the user has made may be initiated by the user by tapping or clicking on a tab, button, or link on the home screen that reads as, for example, “dispute a transaction,” through a suitable input means such as a touch screen, touchpad, or mouse of the user device. In one embodiment, the dispute processing request may be transmitted to, and recognized by, the payment provider immediately at the moment of activating such a tab, button, or link. Or in another embodiment, it may be transmitted to, and recognized by, the payment provider only at the last stage when, after entering all information needed to process a dispute such as selection of transaction(s) to be disputed or selection of item(s) in a transaction have been entered, the user confirms, by tapping or clicking on, for example a “confirm” button or tab, at which moment the dispute information is transmitted to the payment provider simultaneously.

Once the user initiates the process of requesting a dispute processing on the user device, the user may be led to a page for selecting a transaction(s) to be disputed. In one embodiment, the payment provider may have performed payment transactions for the user in the past. In that case, the page will display lists of all the past payment transactions the payment provider has performed for the user to select one or more transactions to dispute. To help the user easily identify a particular transaction to be questioned, the list may show, for each transaction, some key transaction information such as a transaction date, a type of transaction such as “payment,” a payment status such as “completed,” a transaction ID, and net transaction amount. In an embodiment, there may be a further link, for each transaction, which leads to more details, such as location of purchase or list of items purchased, of the selected transaction if, still, the user cannot identify the transaction to dispute by looking at the key transaction information. When there are numerous transactions on the list, a search function may be further provided on the transaction list page to help the user search for a particular transaction with a keyword or date of transaction. Once locating or identifying the transaction to dispute on the list, the user may select it by, for example, clicking or tapping on a tab, button, or link present next to or on the particular transaction.

In another embodiment, the payment provider may not have performed payment transactions for the user, so, the record of purchase, the e-receipt, may be kept by the user, for example, being stored in the user device or other similar devices. In this situation, the transaction selection page may permit the user to upload the electronic receipt (“e-receipt”) for the particular transaction to be disputed. Clicking on, for example, an “upload an e-receipt” button on the page may enable the user to browse a local memory of the user device or any other devices electronically connected thereto, find and upload a desired e-receipt into the user application, which will be transmitted to the payment provider. If the purchase receipt the user keeps is a conventional paper receipt, the user may scan it to obtain a receipt in an electronic format and upload it.

The selection of a particular transaction the user wishes to dispute may lead to another page on the user device, on which the user may be requested to identify the issue(s) of dispute for the selected transaction. For example, in one embodiment, the user may be asked to choose a dispute issue, by clicking on a relevant radio button for example, among issues such as “billing,” “unauthorized transaction,” and “item dispute.” The issue of “billing” may include over or under billing, billing on non-preferred payment instruments such as credit cards, or any other typical billing problems arising from commercial transactions. The user may choose “unauthorized transaction” as the dispute issue if the user believes that the whole payment transaction selected was not authorized by the user, seemingly having stemmed from a purchase transaction that either the user does not recall or did not make. The issue of “item dispute” may cover various issues arising from problems with one or more items purchased in a particular transaction, which will be described in more detail herein below.

If the user selects, for example, “billing” or “unauthorized transaction” as the dispute issue, the user may be directed to another appropriate page, on which the user may be asked to provide more detailed explanation, information, or basis for the selected issue of dispute. The further details requested on each selected dispute issue may be, in one embodiment, categorized and provided by the payment provider on the user application via a drop-down menu for example, or directly entered by the user via typing into an appropriate field popped up,

If the user selects, for example, “item dispute” as the issue of the dispute, then the user application may pop up on the device screen the e-receipt for the particular purchase transaction previously selected, so that the user may select a particular item(s) to be disputed. The e-receipt may be either provided by the payment provider or uploaded from the user as previously noted. The e-receipt may display detailed transaction information such as an item name, item ID or number, item description, price, and quantity for each item purchased, the net amount the user paid, which may be the total amount of purchase after applicable taxes, discounts and a tip, and information of the transaction such as a transaction date, transaction ID, merchant name, address and/or contacts of the purchase place or merchant. In one embodiment, the e-receipt, which has been either retained by the payment provider or uploaded by the user, may include all the detailed transaction information. But if the e-receipt includes only some basic information such as a transaction ID, but not the every detail, the payment provider may, in another embodiment, fetch the detailed transaction information from a merchant server in real time using the transaction ID found on the e-receipt, and display it to the user on the device screen.

In one embodiment, the user may be asked to confirm that the user has communicated or tried to communicate with the merchant to try and resolve the dispute before the request can be processed by the payment provider. For example, the user may be asked to select a box that indicates that the user has contacted or attempted to contact the merchant, along with the result of the contact or attempt.

On the e-receipt displayed, the user may select one or more items for dispute by clicking on, for example, a button, box, or tab placed next to the items. The selected e-receipt and one or more items in it for dispute are then transmitted, from the user device to the service provider at step 102 with a dispute processing request. In one embodiment, the act of the user's loading the user application and clicking on, for example, the “dispute a transaction,” button may constitute sending the dispute processing request to the payment provider. In another embodiment, the payment provider may recognize the dispute processing request at the time the user finishes selection of a particular transaction (and its e-receipt) and particular item(s) from it for dispute, which is immediately communicated to the payment provider from the user device.

Now, continuing to refer to FIG. 1, at step 104, the payment provider determines, from the e-receipt selected, information on a merchant with whom the user had the disputed purchase transaction, a description and an amount of purchase for each of the one or more selections of the items. Since the e-receipt selected by and transmitted from the user includes information on the merchant, including the addresses and contact information (phone numbers, web addresses, Facebook or other social network) of the merchant store, headquarters, or other offices, and the information on the disputed items, the payment provider can immediately retrieve or read from it the information on the merchant and the item description and purchase price of each item the user selected for dispute, which would be necessary for processing the dispute on the user's behalf. The amount or purchase price of each item may be either the face price of the item or the net price the user actually paid to the merchant for the item, which may be the item price after applying any applicable taxes or discounts on it.

Still referring to FIG. 1, at step 106, the payment provider receives, from the user via the device, a reason for the dispute for each of the one or more selections of the items. Once one or more particular item(s) to dispute is selected from the e-receipt of a particular transaction selected, then the user application may lead the user to another page where the user may enter the reason for the dispute for each selected item. In an embodiment, the payment provider may provide the user, through the user application, with pre-selected reasons via, for instance, a drop bar menu or list of reasons with a radio button placed next to each reason for the user's selection.

Also, in an embodiment, to help the user make sure that she or he is choosing or entering the dispute reason for the right item, there may be provided fields, for each selected item, to show the item description and item price, placed next to the field of dispute reason. These fields would be particularly needed if there are multiple items selected for dispute and all selected items are shown on a same page with respective fields of dispute reasons. Since the payment provider previously determined and therefore knows the item description and item price from the e-receipt at step 104, in an embodiment, it may pre-populate or automatically fill the respective fields with the item description and item price it determined.

The pre-selected dispute reasons provided to the user to choose from may include, for example, “Item not received,” “Received wrong item,” “Item significantly not as described,” “Defective,” and so on. If the user cannot find the right reason out of the list of pre-selected reasons, or feels that there is need to elaborate the particular reason the user chose from the list, the user may type the right reason or more detailed explanation to the selected reason into a separate field provided next to each item. For example, if the user chooses “Item significantly not as described” as the dispute reason, the user may need to further explain why the user wants to return the item, or more specifically, why and in what aspect, the item she or he purchased falls short, in function, in performance, in quality, in duration, sturdiness, or in whatever other aspect, of what has been described or promised about the item in the item description or advertisement. In one embodiment, the user may be also asked to determine the type of item to be returned or disputed, as well as one or more reasons the merchant did not accept the return, which may be provided to the user as a list of reasons with check boxes for the user to select from with a field to enter a specific reason if the list does not include a suitable reason.

Further, in an embodiment, the user may be allowed to enter, and thereby transmit to the payment provider, a requested amount of refund for each of the one or more selections of the items. There may be occasions when the user does not wish, or cannot obtain, a full refund from the merchant for any disputed item by returning it to the merchant for various reasons. In some case, the item may not be wholly defective or dissatisfactory to demand a full refund of a purchase price, in which case the user may wish to keep the item and demand a partial refund as a compensation for whatever loss generated by the defect or dissatisfaction. Or in another case, there may be a merchant's refund policy that bars a full refund after a proscribed period. In that case, the maximum amount of refund allowed may be proscribed as, for example, layered percentages of the purchase price, depending on the time lapsed after the date of purchase. For whatever reasons the user wishes a refund for a disputed item other than the full purchase price, the user may enter, with a suitable entry means, the refund amount she or he wants, either in dollar amount or percentage of the purchase price, into a field that may read, for example, “requested amount of refund.”

After the user finishes entering all information needed to request a dispute processing, the payment provider may display on the page a summary of all information including what the user entered and what the payment provider self-determined from the e-receipt selected by the user for the user's final review and confirmation. If any part of the displayed information is incorrect, the user is given a chance to edit that part of the information by, for example, tapping or clicking on a “edit” button or tab shown on the screen next to the erroneous entry, which will pop up another window in which the user may conduct a necessary editing. After making sure that all information for the dispute processing is correct, the user may finalize the process of requesting a dispute processing by tapping or clicking on, for example, a “confirm” or “transmit” tab or button on the page.

Still referring to FIG. 1, now at step 108, the payment provider processes the dispute by utilizing the merchant information, the description, the amount of purchase and the dispute reason for each of the one or more selections of the items. Processing the dispute by the payment provider on the user's behalf may be initiated by sending, for example, a dispute form or a notice of dispute to the merchant. The dispute form has all the information about the dispute filled in, some directly received by the user, such as the user identification, identification of the disputed transaction through the selection of the e-receipt, selection of item(s), and the dispute reason(s), and the others determined by the payment provider from the e-receipt, such as the merchant identification, the place and date of purchase, the transaction ID, the descriptions and prices of disputed item(s), the total amount of transaction, and a requested amount of refund for each disputed item if different from the full purchase price. The dispute form sent to the merchant or a suitable legal or customer service, or dispute resolution department thereof may be a physical paper form printed out by the payment provider or a digital form transmitted electronically. One the dispute processing is initiated, the payment provider continues the process according to some predetermined procedures as it receives responses from the merchant until the dispute is resolved. If necessary during the process, the payment provider may use, upon the approval of the user, a third party dispute resolution or mediation service for resolving the dispute.

In one embodiment, during the dispute process, the status of the dispute processing may be communicated to the user either by the initiation of the payment provider through an email or other means of communication, or by the user's request. For example, on the home page of the user application on the user device or a separate home page of the payment provider, the user may find a button, tab, or link that reads as “Check status of dispute.” Tapping or clicking on it will request the user to login or enter a user ID, which may lead the user to another page showing the list of all disputes being processed for the user. Choosing one may display the current status and the history of the processing between the payment provider and the merchant. In some embodiment, the payment provider may allow the user to supplement or modify any information, such as dispute reasons, or to upload another supporting material or evidence for the particular dispute being processed.

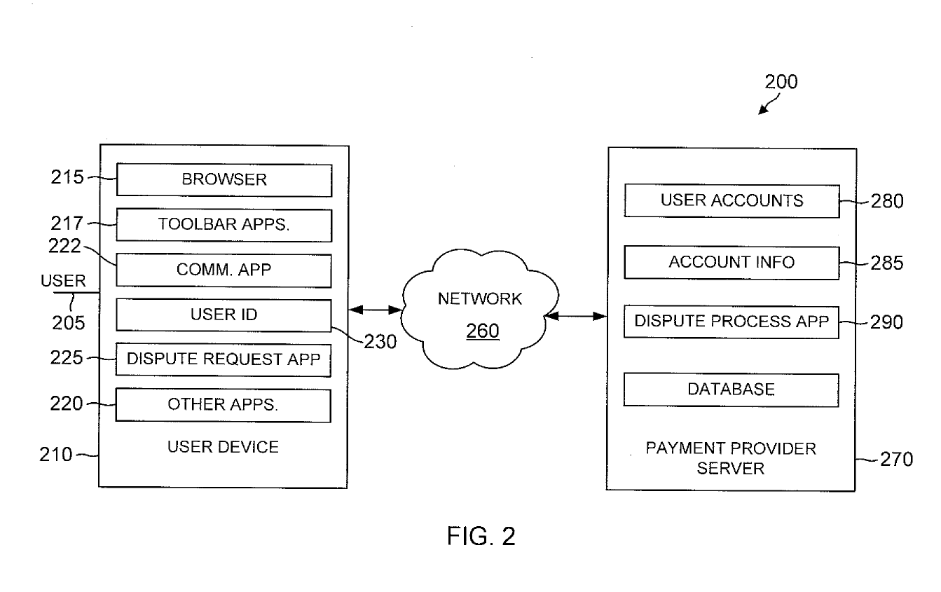

FIG. 2 is a block diagram of a networked system 200 configured to handle a transaction, such as described above, in accordance with an embodiment of the invention. System 200 includes a user device 210 and a payment provider server 270 in communication over a network 260. Payment provider server 270 may be maintained by a payment provider, such as PayPal, Inc. of San Jose, Calif. A user 205 utilizes the user device 210 to request to the payment provider server 270 to process a dispute with a merchant/vendor and transmit relevant information. Although only one user device is shown, a plurality of user devices may be connected to the payment provider server 270 if there are multiple users having accounts with the payment provider.

The user device 210 and payment provider server 270 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 200, and/or accessible over network 260.

The network 260 may be implemented as a single network or a combination of multiple networks. For example, in various embodiments, network 260 may include the Internet or one or more intranets, landline networks, wireless networks, and/or other appropriate types of networks.

The user device 210 may be implemented using any appropriate hardware and software configured for wired and/or wireless communication over network 260. For example, in one embodiment, the user device 210 may be implemented as a personal computer (PC), a smart phone, personal digital assistant (PDA), laptop computer, tablet, and/or other types of computing devices capable of transmitting and/or receiving data, such as an iPad™ from Apple™.

The user device 210 may include one or more browser applications 215 which may be used, for example, to provide a convenient interface to permit the user 205 to browse information available over network 260. For example, in one embodiment, browser application 215 may be implemented as a web browser configured to view information available over the Internet, and/or access merchant sites for viewing and purchasing commercial products. The user device 210 may also include one or more toolbar applications 217 which may be used, for example, to provide client-side processing for performing desired tasks in response to operations selected by the user 205. In one embodiment, the toolbar application 217 may display a user interface in connection with the browser application 215 as further described herein.

The user device 210 may further include a dispute request application 225 by which the user 205 may transmit, to the payment provider server 270 via network 260, a user identifier, a request to process a dispute for a purchase transaction, selection of an electronic receipt (e-receipt) for the disputed purchase transaction, and one or more selections of items on the e-receipt to be disputed. The dispute request application 225 may be incorporated into the browser 215 in one embodiment.

The user device 210 may further include other applications 220 as may be desired in particular embodiments to provide desired features to user device 210. For example, other applications 220 may include security applications for implementing client-side security features, programmatic client applications for interfacing with appropriate application programming interfaces (APIs) over network 260, or other types of applications. The applications 220 may also include email, texting, voice and IM applications that allow the user 205 to send and receive emails, calls, and texts through network 260, as well as applications that enable the user 205 to communicate, transfer information, and make payments. The user device 210 includes one or more user identifiers 230 which may be implemented, for example, as operating system registry entries, cookies associated with browser application 215, identifiers associated with hardware of the user device 210, or other appropriate identifiers, such as used for payment/user/device authentication. In one embodiment, user identifier 230 may be used by a payment provider to associate the user 205 with a particular account maintained by the payment provider as further described herein. A communications application 222, with associated interfaces, enables the user device 210 to communicate within system 200.

The payment provider server 270 may be maintained, for example, by an online service payment provider which may process a dispute on behalf of the user 205. The payment provider server 270 also maintains a plurality of user accounts 280, each of which may include account information 285 associated with individual users. For example, the account information 285 may include private financial information of users such as account numbers, passwords, device identifiers, user names, phone numbers, credit card information, bank information, or other financial information, and/or shipping information.

The payment provider server 270 includes a dispute processing application 290 which may be configured to interact with the user device 210 over network 260 to facilitate processing a dispute on the user's behalf and receive/transmit information, as described in the process 100 in FIG. 1. Specifically, the dispute processing application 290 is configured to receive from the user device 210 information comprising a request to process a dispute for a purchase transaction, selection of an electronic receipt (e-receipt) for the disputed purchase transaction, and one or more selections of items on the e-receipt to be disputed, and determine other information necessary to process the dispute.

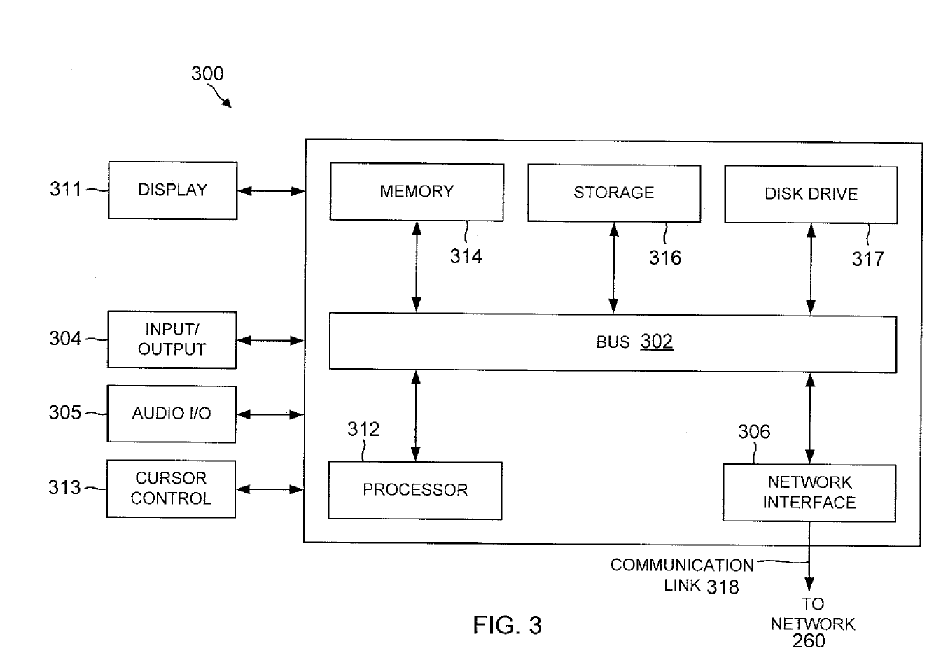

FIG. 3 is a block diagram of a computer system 300 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 300 in a manner as follows.

Computer system 300 includes a bus 302 or other communication mechanism for communicating information data, signals, and information between various components of computer system 300. Components include an input/output (I/O) component 304 that processes a user action, such as selecting keys from a keypad/keyboard, selecting one or more buttons or links, etc., and sends a corresponding signal to bus 302. I/O component 304 may also include an output component, such as a display 311 and a cursor control 313 (such as a keyboard, keypad, mouse, etc.). An optional audio input/output component 305 may also be included to allow a user to use voice for inputting information by converting audio signals. Audio I/O component 305 may allow the user to hear audio. A transceiver or network interface 306 transmits and receives signals between computer system 300 and other devices, such as another user device, a merchant server, or a payment provider server via network 260. In one embodiment, the transmission is wireless, although other transmission mediums and methods may also be suitable. A processor 312, which can be a micro-controller, digital signal processor (DSP), or other processing component, processes these various signals, such as for display on computer system 300 or transmission to other devices via a communication link 318. Processor 312 may also control transmission of information, such as cookies or IP addresses, to other devices.

Components of computer system 300 also include a system memory component 314 (e.g., RAM), a static storage component 316 (e.g., ROM), and/or a disk drive 317. Computer system 300 performs specific operations by processor 312 and other components by executing one or more sequences of instructions contained in system memory component 314. Logic may be encoded in a computer readable medium, which may refer to any medium that participates in providing instructions to processor 312 for execution. Such a medium may take many forms, including but not limited to, non-volatile media, volatile media, and transmission media. In various implementations, non-volatile media includes optical or magnetic disks, volatile media includes dynamic memory, such as system memory component 314, and transmission media includes coaxial cables, copper wire, and fiber optics, including wires that comprise bus 302. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 318 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system of a payment provider comprising:
a memory storing account information for a user; and
one or more processors in communication with the memory, the one or more processors being configured to:
receive, from the user via a user device, a request to process a dispute for a purchase transaction, a selection of an electronic receipt (e-receipt) for the disputed purchase transaction, and one or more selections of items on the e-receipt to be disputed;
determine, from the e-receipt selected, merchant information on a merchant with whom the user had the disputed purchase transaction, a description and an amount of purchase for each of the one or more selections of the items;
receive, from the user via the device, a dispute reason for each of the one or more selections of the items; and
process the dispute by utilizing the merchant information, the description, the amount of purchase and the dispute reason for each of the one or more selections of the items.

2. The system of claim 1, wherein the e-receipt is stored in the memory and associated with the account information.

3. The system of claim 1, wherein the e-receipt is stored in the user device.

4. The system of claim 1, the one or more processors is further configured to communicate to the user on the user device the description and the amount of purchase for each of the one or more selections of the items.

5. The system of claim 1, wherein the one or more processors is further configured to receive, from the user via the user device, a requested amount of refund for each of the one or more selections of the items.

6. The system of claim 1, wherein the one or more processors is further configured to process the dispute by transmitting to the merchant a dispute form including the merchant information, the description, the amount of purchase and the dispute reason for each of the one or more selections of the items.

7. The system of claim 1, wherein the one or more processors is further configured to communicate a status of the dispute processing to the user.

8. A method for performing a transaction using a user device, comprising:
receiving, from a user via the user device by one or more processors of a payment provider, a request to process a dispute for a purchase transaction, a selection of an electronic receipt (e-receipt) for the disputed purchase transaction, and one or more selections of items on the e-receipt to be disputed;
determining from the e-receipt selected, by the one or more processors, merchant information on a merchant with whom the user had the disputed purchase transaction, a description and an amount of purchase for each of the one or more selections of the items;
receiving, from the user via the user device by the one or more processors, a dispute reason for each of the one or more selections of the items; and
processing, by the one or more processors, the dispute by utilizing the merchant information, the description, the amount of purchase and the dispute reason for each of the one or more selections of the items.

9. The method of claim 8, wherein the e-receipt is stored in the memory and associated with the account information.

10. The method of claim 8, wherein the e-receipt is stored in the user device.

11. The method of claim 8, further comprising communicating, by the one or more processors, to the user on the user device the description and the amount of purchase for each of the one or more selections of the items.

12. The method of claim 8, further comprising receiving, from the user via the user device by the one or more processors, a requested amount of refund for each of the one or more selections of the items.

13. The method of claim 8, wherein the step of processing the dispute comprises transmitting to the merchant a dispute form including the merchant information, the description, the amount of purchase and the dispute reason for each of the one or more selections of the items.

14. The method of claim 8, wherein the one or more processors is further configured to communicate a status of the dispute processing to the user.

15. A non-transitory machine-readable medium comprising a plurality of machine-readable instructions which, when executed by one or more processors of a server, are adapted to cause the server to perform a method comprising:
receiving, from a user via a user device, a request to process a dispute for a purchase transaction, a selection of an electronic receipt (e-receipt) for the disputed purchase transaction, and one or more selections of items on the e-receipt to be disputed;
determining, from the e-receipt, selected merchant information on a merchant with whom the user had the disputed purchase transaction, a description and an amount of purchase for each of the one or more selections of the items;
receiving, from the user via the user device, a dispute reason for each of the one or more selections of the items; and
processing the dispute by utilizing the merchant information, the description, the amount of purchase and the dispute reason for each of the one or more selections of the items.

16. The non-transitory machine-readable medium of claim 15, wherein the e-receipt is stored in the memory and associated with the account information.

17. The non-transitory machine-readable medium of claim 15, wherein the e-receipt is stored in the user device.

18. The non-transitory machine-readable medium of claim 15, wherein the method further comprises communicating to the user on the user device the description and the amount of purchase for each of the one or more selections of the items.

19. The non-transitory machine-readable medium of claim 15, wherein the method further comprises receiving, from the user via the user device, a requested amount of refund for each of the one or more selections of the items.

20. The non-transitory machine-readable medium of claim 15, wherein the step of processing the dispute in the method comprises transmitting to the merchant a dispute form including the merchant information, the description, the amount of purchase and the dispute reason for each of the one or more selections of the items.

21. The non-transitory machine-readable medium of claim 15, wherein the method further comprises communicating a status of the dispute processing to the user.
